(19) United States
(12) Patent Application Publication
(10) Pub. No.: US 2007/0277442 A1
(43) Pub. Date: Dec. 6, 2007

(54) Motorized in-line sliding window

(75) Inventors: Sabin Dery, Laval (CA); Rejeap Daoust, Valleyfield (CA); Gino Grondin, Vaudreuil (CA)

Correspondence Address: OGILVY RENAULT LLP, 1981 MCGILL COLLEGE AVENUE, SUITE 1600, MONTREAL, QC, H3A2Y3, US

(73) Assignee: Pyramid Specialty Products Ltd.

(21) Appl. No.: 11/455,829

(22) Filed: Jun. 20, 2006

(30) Foreign Application Priority Data
Jun. 2, 2006 (CA) 2,535,229

(51) Int. Cl. E05F 11/40

(52) U.S. Cl. 49/362

(57) ABSTRACT

A motorized in-line sliding window structure is described. The sliding window structure comprises a window frame having upper and lower slide rails. A fixed glass is provided in the frame and a displaceable window panel. Guide channels are provided in the slide rails to guide the displaceable window panel from a closed position, where the displaceable panel is disposed in a substantially common plane with the fixed glass, to an offset open position, where the displaceable window panel is retracted out of the common plane and displaced along the guide channels in the slide rails to a desired position behind the fixed window panel. An electric motor is connected to flexible cables to displace the displaceable window panel along the guide channels. The flexible cables and their connectors are displaceable in a concealed routed channel associated with a guide channel of said slide rails.

### TECHNICAL FIELD

The present invention relates to a motorized in-line sliding window structure.

### BACKGROUND ART

In-line sliding window structures are known wherein a sliding window pane, which is displaced next to a fixed window pane, is retracted and displaced on a track behind the fixed window pane, but these are usually operated manually.

### SUMMARY OF INVENTION

It is a feature of the present invention to provide a motorized in-line sliding window structures.

According to the above feature, from a broad aspect, the present invention provides a motorized in-line sliding window structure. The sliding window structure comprises a window frame having opposed parallel slide rails. A fixed glass is provided in the frame and a displaceable window panel. Guide means is provided in the slide rails to guide the displaceable window panel from a closed position, where the displaceable panel is disposed in a substantially common plane with the fixed panel, to an offset open position where the displaceable window panel is retracted out of the common plane and displaced along the slide rails to a desired position behind the fixed window panel. Electrically operated controllable means is secured to concealed, flexible attachment means to displace the displaceable window panel along the guide means.

### BRIEF DESCRIPTION OF DRAWINGS

A preferred embodiment of the present invention will now be described with reference to the accompanying drawings in which:

FIG. 1 is a front view showing an in-line sliding window structure constructed in accordance with the present invention and illustrating the position of the electric motor and the two flexible cables associated with its drive sprocket and their position with respect to the frame;

FIG. 2 is a section view along section lines F-F of FIG. 1;

FIG. 3 is an exploded perspective view showing the construction of the in-line sliding window structure of the present invention;

FIG. 4 is a section view along section lines D-D of FIG. 1 looking down on the upper surface of the lower guide rail;

FIG. 5 is a section view along section lines B-B of FIG. 1 looking at the bottom surface of the lower guide rail;

FIG. 6 is a fragmented section of detail E of FIG. 4;

FIG. 7A is a fragmented perspective view of an end section of a flexible cable showing the construction of the rigid connector and the pivotal link arm;

FIG. 7B is a section view of detail C of FIG. 5 and showing the link arm disconnected from its panel connector;

FIG. 7C is a view similar to FIG. 7B but showing the link arm connected to the panel connector;

FIG. 8 is a fragmented sectional side view of detail G of FIG. 2, showing the lower guide rail construction concealing a position of the flexible cable; and

FIG. 9 is a fragmented schematic view showing the construction of the flexible cable and its engagement with the driven sprocket disc ear.

### DESCRIPTION OF PREFERRED EMBODIMENTS

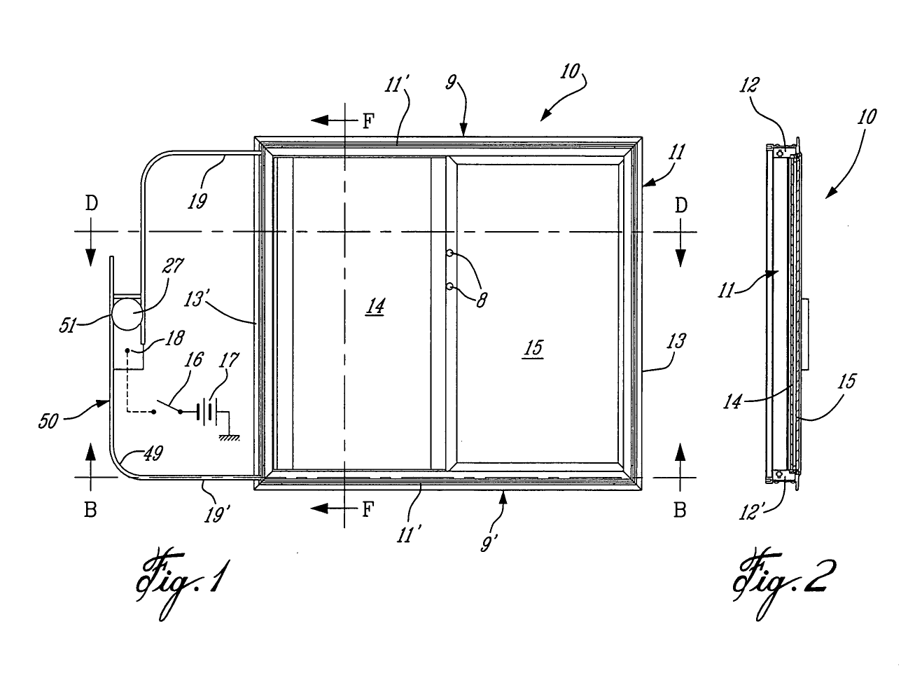

Referring to the drawings and more particularly to FIGS. 1 to 3, there is shown generally at 10 an in-line sliding window structure constructed in accordance with the present invention. This sliding window structure comprises a window frame 11 which has upper and lower horizontal stiles 9 and 9′ and vertical side stiles 13 and 13′. A fixed glass 14 is secured in the frame. A displaceable window panel 15 is displaceably secured within the frame and displaceable between upper and lower slide rails 12 and 12′ retained within the horizontal stiles. When the displaceable window panel is in a closed position, it lies substantially in a common plane with the fixed glass panel 14, as shown in FIGS. 1 and 2. Escape pins 8 provide for emergency release of the panel 15. A screen 7 may also be secured in the frame.

It is pointed out that the embodiment herein-described is that of a horizontal window frame but it can also be a vertically mounted frame where the slide rails would be secured in opposed parallel vertical stiles.

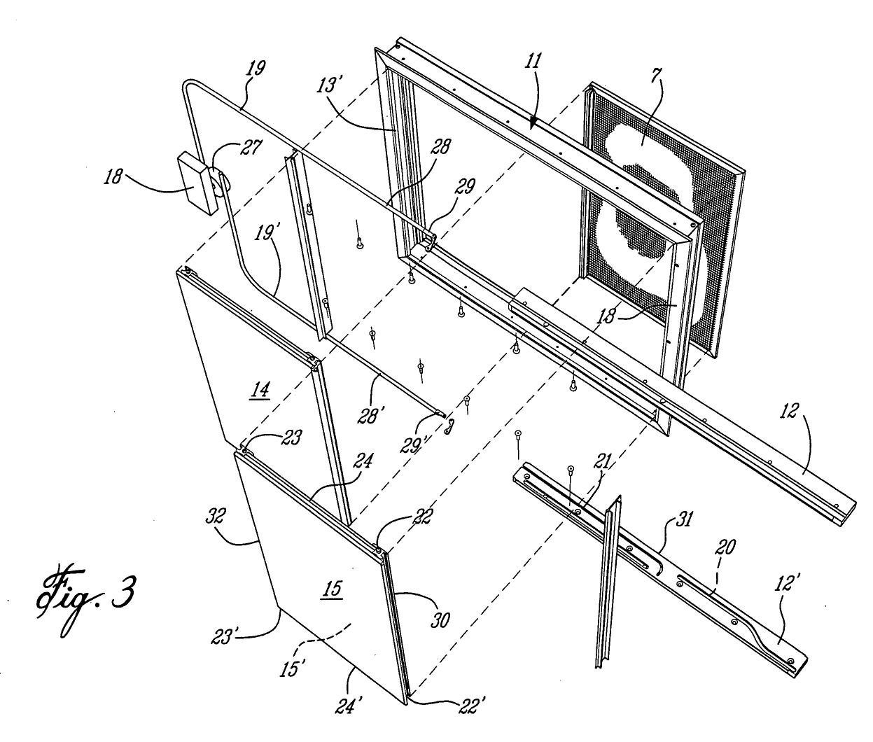

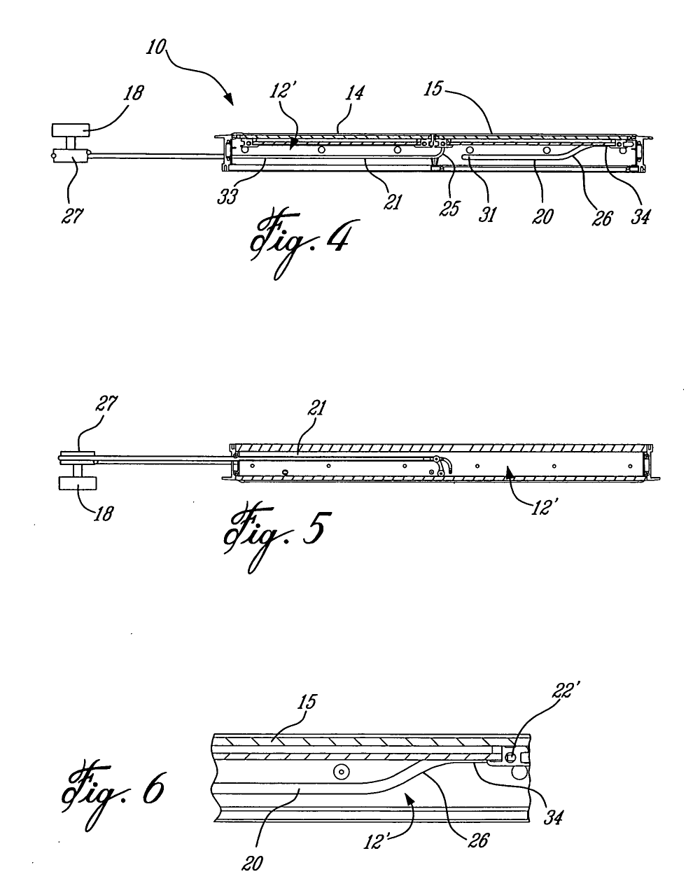

Referring now more specifically to FIGS. 3 to 6, there is illustrated the guide means in the upper and lower slide rails 12 and 12′ to guide the displaceable window panel 15 from a closed position, where the displaceable panel is disposed in a substantially common plane with the fixed panel, and to an offset open position where the displaceable window panel 15 is retracted out of this common plane and displaced along the slide rails 12 and 12′ to a desired position behind the fixed window panel 14. This displacement is effected automatically by a person by depressing a switch 16 conveniently accessible to him whereby to connect a power supply 17 to a drive motor 18, as illustrated in FIG. 1. The drive motor 18 displaces flexible attachment means, herein provided by flexible cables 19 and 19′, each connected to a respective one of a top end and bottom end of the displaceable window panel as will be described in more detail later. The motor and cables are concealed in the vehicle wall or elsewhere and not visible.

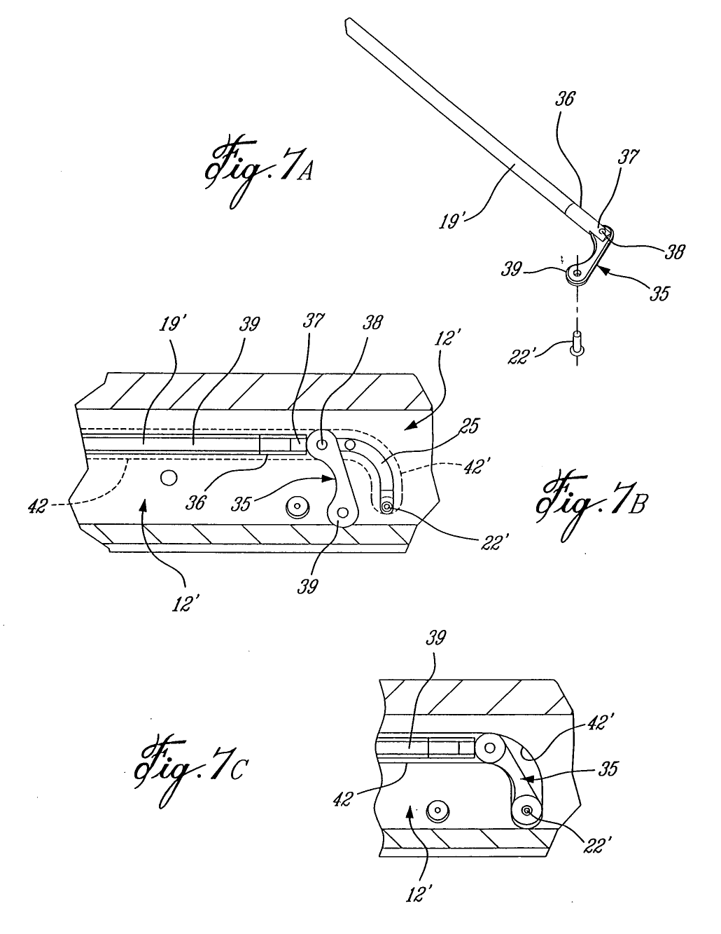

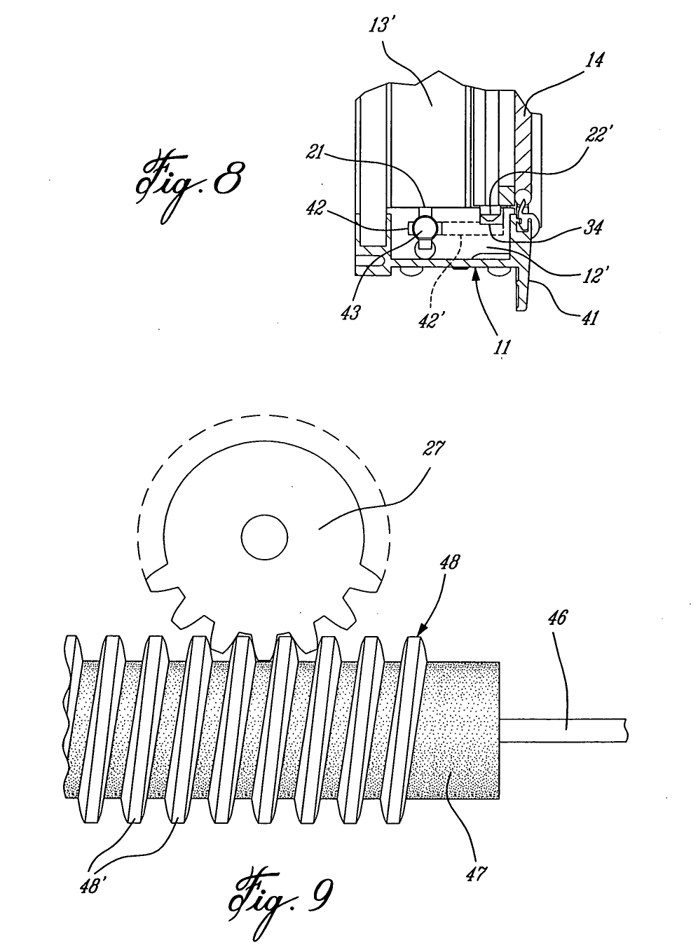

The displaceable window panel 15 is displaced in a guided manner along guide channels 20 and 21 formed in the upper and lower slide rails 12 and 12′. The shapes of these channels are illustrated more clearly in FIGS. 4 to 6. As hereinshown, one of the guide channels, channel 21, is disposed offset behind the plane of the fixed window panel 14 and the other one is disposed behind the displaceable window panel 15. The displaceable window panel 15 is provided with follower elements 22 and 23 in the form of guide pins which extend from top and lower edges 24 and 24′ of the displaceable window panel 15 and adjacent opposed ends thereof. These follower elements or guide pins 22 are displaceably engaged with a respective one of the guide channels 20 and 21. The follower elements 22 and 22′ are engaged in the channel 20 which are machined in the inner surfaces of the slide rails 12 and 12′ facing the frame opening on the displaceable window panel. The follower elements 23 and 23′ are engaged in the channel 21 which is an internally routed channel as will be described later with reference to FIGS. 7A to 8.

The guide channels 20 and 21 have angulated sections 25 for channel 21 and 26 for channel 20 to guidingly displace the displaceable window panel 15 to the offset position or the closed position. The flexible cables 19 and 19′ are connected at one end to a sprocket disc gear 27 of the electric motor 18 and at their opposite ends 28 and 28′ to a panel connector 29 and 29′ (see FIG. 3). These panel connectors 29 and 29′ are connected respectively to a connecting end of the follower elements 23 and 231.

As can be seen more clearly in FIG. 4, when the displaceable window panel 15 is retracted by the motor 27, the far edge 30 of the displaceable window panel 15 is disposed substantially at the end 31 of the track 20. When the panel is displaced to a closed position, that far edge 30 follows the track 20 and enters into the angle section whereat such position the near edge 32 is still positioned over the straight section 33 of the guide channel 21 with the displaceable window panel being angulated and the far edge 30 then slides along a straight end section 34 of the track 20 which positions the follower elements 22 and 22′ in the same plane as the window pane 14 and then the near edge 32 of the window pane 15 enters the angulated section 25 (see FIG. 7B) where it is pushed into the common plane with the fixed window pane. In order to do this, there is provided a pivotal link connector assembly 35 at each end of the flexible cables 19 and 19′.

The pivotal link connector assembly 35 is comprised of a rigid connector 36 secured to the end of the flexible cables 19 and 19′ and which has a fork end 37 across which is secured a connecting pin 38 to pivotally connect a pivotal link arm 39 between the fork end. This connection is schematically illustrated in FIG. 7B wherein one end of the link arm is secured to the connector pin 38. The other end will secure to the follower element or guide pin 22′ at the bottom of the displaceable window panel and which projects in the routed channel 21 to a cable receiving channel 43, as shown in FIG. 8.

The link arm 39 has an arcuate shoulder portion at one end in frictional contact with a free end surface of the rigid connector 36. As shown in FIG. 7B, the angulated section 25 of the guide channel 33 has a transverse arcuate end section 25 to guide the displaceable panel to the closed position. The link arm 39 is rotated on the connecting pin 38 when one of the follower elements 22′ is guided into the transverse arcuate section 25.

Referring now to FIG. 8, there is shown the construction of the upper and lower guide rails 12 and 12′, herein the lower guide rail 12′. It is comprised of an extrusion 41 in which there is routed from an end thereof the channel 21 having an internal cross-sectional configuration as illustrated. The channel 21 has an internal straight circular channel 43 wherein the flexible cables 19 and 19′ are housed and displaced along their long axis in a straight guided manner. A transverse rectangular slot 42 is routed across the circular channel 43 and extends on both sides thereof and in which the link arm 39 is displaced. The rectangular slot 42 follows the configuration of the channel 21 and is curved along end section 42′. As shown in FIGS. 7B and 7C, the flexible cable remains along a substantially straight axis 45 during its displacement in the channel 43 but the pivotal link arm 39 will enter the slot end section 42′ and will guide the guide pin 22′ to the end of the arcuate channel 25 and bridge this arcuate section as illustrated in FIG. 7C. The drive sprocket disc 27 which is in engagement with the drive motor arrests the flexible cable in any position and thus locks the displaceable window frame through its toothed engagement with these cables as will now be described.

As shown in FIG. 9, the flexible cables are comprised by a flexible wire rod 46 covered by a flexible, sound-absorbing, spring support jacket 47. A flexible spiral memory spring 48 is wound about the jacket 47. Accordingly, this assembly will be highly flexible and capable of being displaced along curved sections, such as the curved section 49 of concealed guide tubes 50 in which such cables are displaced. However, these tubes 50 have a side opening 51 in which the teeth 52 of the sprocket disc 27 project and engage between the spirals 48′ of the flexible spring 48. Therefore, the cable can be displaced longitudinally by the rotation of the sprocket disc 27. The guide tubes 50 constitute guide means, such as the channel 43, to house these cables and direct them along precise oriented paths. These guide tubes 50 and the motor are small and easy to conceal in framework adjacent the window frame 11.

It is within the ambit of the present invention to cover any obvious modifications of the preferred embodiment described herein, provided such modification fall within the scope of the appended claims.

We claim:

1. A motorized in-line sliding window structure, said sliding window structure comprising a window frame having opposed parallel slide rails, a fixed glass in said frame and a displaceable window panel; guide means is provided in said slide rails to guide said displaceable window panel from a closed position, where said displaceable panel is disposed in a substantially common plane with said fixed glass, to an offset open position where said displaceable window panel is retracted out of said common plane and displaced along said slide rails to a desired position behind said fixed window panel, and electrically operated controllable means secured to concealed flexible attachment means to displace said displaceable window panel along said guide means.

2. A motorized in-line sliding window structure as claimed in claim 1 wherein said electrically operated controllable means is an electric motor having a driven element coupled to said flexible attachment means.

3. A motorized in-line sliding window structure as claimed in claim 2 wherein said opposed parallel slide rails are upper and lower horizontal slide rails.

4. A motorized in-line sliding window structure as claimed in claim 2 wherein said opposed parallel slide rails are opposed parallel vertical slide rails.

5. A motorized in-line sliding window structure as claimed in claim 3 wherein said guide means is constituted by two guide channels formed in said upper and lower horizontal slide rails, one of said guide channels being disposed offset behind a panel of said fixed window panel and the other behind said displaceable window panel, said displaceable window panel having follower elements in a top and lower edge thereof adjacent opposed ends thereof and displaceably engaged with a respective ones of said guide channels, said guide channels having angulated sections to guidingly displace said displaceable window panel to said closed and offset positions, said flexible attachment means being comprised by a pair of flexible cables coupled at one end to said driven element of said electric motor and connected at an opposite end to a respective panel connector of said top and lower edge of said displaceable window panel.

6. A motorized in-line sliding window structure as claimed in claim 5 wherein said pair of flexible cables are retained captive in guide means disposed in said window frame, each said flexible cable having a pivotal link connector assembly secured to said opposite end thereof and to said panel connector.

7. A motorized in-line sliding window structure as claimed in claim 6 wherein said pivotal link connector assembly is comprised of a rigid connector secured to a free end of said flexible cables at said opposite end thereof, said connector having a fork end, a connecting pin projecting through said fork end, and a pivotal link arm pivotally secured at one end to said connecting pin and pivotally secured at an opposed end to said panel connector.

8. A motorized in-line sliding window structure as claimed in claim 7 wherein said link arm has an arcuate shoulder portion at said one end in frictional contact with a free end surface of said rigid connector, said guide channel positioned behind said fixed window panel being a routed channel having a straight channel section to receive one of said cables and a link arm receiving recessed portion extending into an angulated transverse arcuate end section to guide said displaceable panel to said closed position, said link arm being rotated on said connecting pin when one of said follower elements is guided into said transverse arcuate end section.

9. A motorized in-line sliding window structure as claimed in claim 8 wherein said panel connector is constituted by said one of said follower elements, said follower elements being pins secured in opposed ends of opposed vertical stiles of said displaceable window panel.

10. A motorized in-line sliding window structure as claimed in claim 8 wherein said guide means is constituted by said straight channel section of said routed channel formed in said upper and lower slide rails, said flexible cable being displaced in said internal straight channel with said one of said follower elements connected thereto extending into said link arm receiving recessed portion.

11. A motorized in-line sliding window structure as claimed in claim 5 wherein said flexible cables are comprised by a flexible wire rod covered by a flexible, sound-absorbing, spring support jacket; and a flexible spiral spring about said jacket.

12. A motorized in-line sliding window structure as claimed in claim 11 wherein said driven element is a sprocket disc gear having circumferential teeth dimensioned and spaced for engagement between windings of said spiral spring in a section of said two cables adjacent said one end thereof for axial displacement of said two cables in further guide means extending in parallel relationship on opposed sides of said sprocket disc gear whereby said cables are displaced in unison.

13. A motorized in-line sliding window structure as claimed in claim 12 wherein said electric motor, said sprocket disc gear and said further guide means are concealed in a structure adjacent said window frame.
